(19) United States
(12) Patent Application Publication
(10) Pub. No.: US 2011/0310171 A1
(43) Pub. Date: Dec. 22, 2011

(54) Dual print head wiper apparatus for a two-pen ink jet printer and method for cleaning ink pen faces of a two-pen ink jet printer

(75) Inventors: Steven A. Supron, Ithaca, NY (US); Jeffrey S. Koepele, Ithaca, NY (US)

(73) Assignee: TransAct Technologies Incorporated, Hamden, CT (US)

(21) Appl. No.: 12/803,248

(22) Filed: Jun. 21, 2010

(51) Int. Cl. B41J 2/165

(52) U.S. Cl. 347/33

(57) ABSTRACT

Apparatus and methods are provided for simultaneously cleaning both ink pen faces of a two-pen ink jet printer. Two print head wipers are provided, each print head wiper being adapted to wipe a respective ink pen face of a corresponding ink pen. Linkage connects the two print head wipers together. A solenoid is connected to the linkage for actuating the two print head wipers simultaneously.

### BACKGROUND OF THE INVENTION

The present invention relates to a dual print head wiper apparatus for a two-pen ink jet printer and corresponding methods. More specifically, the present invention relates to apparatus and methods for simultaneously cleaning both ink pen faces of a two-pen ink jet printer.

Ink jet printers typically employ a wiper for cleaning the ink pen face of the ink pen. In ink jet printers that employ two ink pens (i.e., color ink jet printers), fixed wipers are used which are located outside of the print zone and/or wipers which do not lock into position during the wiping operation.

However, it is advantageous to provide an ink jet printer with a pivoting frame that permits drop-in paper loading of a roll of paper, so that the paper from the roll does not need to be threaded through the paper path of the printer. With such a printer, fixed wipers are not feasible due to the pivoting frame.

It would therefore be advantageous to provide an ink jet printer with a pivoting frame that permits drop-in paper loading, which also includes a movable dual wiper system that simultaneously cleans both ink pen faces of a two-pen ink jet printer. In addition, it would be advantageous to enable such print head wipers to lock in position during a wiping operation.

The apparatus and methods of the present invention provide the foregoing and other advantages.

### SUMMARY OF THE INVENTION

The present invention relates to apparatus and methods for simultaneously cleaning both ink pen faces of a two-pen ink jet printer.

In one example embodiment in accordance with the present invention, a dual print head wiper apparatus for an ink jet printer is provided. The apparatus comprises two print head wipers, each print head wiper adapted to wipe a respective ink pen face of a corresponding ink pen, linkage connecting the two print head wipers together, and a solenoid connected to the linkage for actuating the two print head wipers simultaneously.

A pivoting frame may be provided for housing the two print head wipers. The pivoting frame may pivot between an open and a closed position. The open position may permit drop-in paper loading and the closed position may enable the print head wipers to engage the respective ink pen faces when the solenoid is actuated.

A carriage may be provided for housing and positioning the ink pens. The carriage moves the ink pens past the print head wipers after activation of the solenoid to initiate the wipe.

In one example embodiment of the present invention, the linkage may comprise an elongated bracket with a cam pivotally mounted on each end of the bracket. Each of the cams may interact with a respective wiper mount holding one of the two print head wipers. Upon actuation of the solenoid, the bracket may be moved in a first direction. The cams may then translate motion from the first direction to a motion in a second direction transverse to the first direction.

Return springs may be provided which bias the respective wiper mounts in a direction opposite the second direction. A linkage return spring may also be provided which is biased to return the linkage to a rest position in an un-activated state of the solenoid.

The present invention also includes methods corresponding to the above-described apparatus. An example embodiment of a method for cleaning ink pen faces of a two-pen ink jet printer in accordance with the present invention may comprise: providing two print head wipers, each print head wiper adapted to wipe a respective ink pen face of a corresponding ink pen; connecting the two print head wipers together; and actuating the two print head wipers simultaneously.

The method embodiments of the present invention may also include various features of the apparatus embodiments discussed above.

### BRIEF DESCRIPTION OF THE DRAWINGS

The present invention will hereinafter be described in conjunction with the appended drawing figures, wherein like reference numerals denote like elements, and:

FIG. 1 shows an example embodiment of a two-pen ink jet printer apparatus in accordance with the present invention, with the pivoting frame in a closed position;

FIG. 2 shows an example embodiment of a two-pen ink jet printer apparatus in accordance with the present invention, with the pivoting frame in an open position;

FIG. 3 shows a further view of the example embodiment of a two-pen ink jet printer apparatus of FIG. 2, with the pivoting frame in an open position;

FIG. 4 shows a dual print head wiper apparatus with the print head wipers in an inactive position in accordance with an example embodiment of the present invention;

FIG. 5 shows the dual print head wiper apparatus of FIG. 1 with the print head wipers in an active position; and

FIG. 6 shows a close-up view of the print head wiper in engagement with an ink pen face in accordance with an example embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

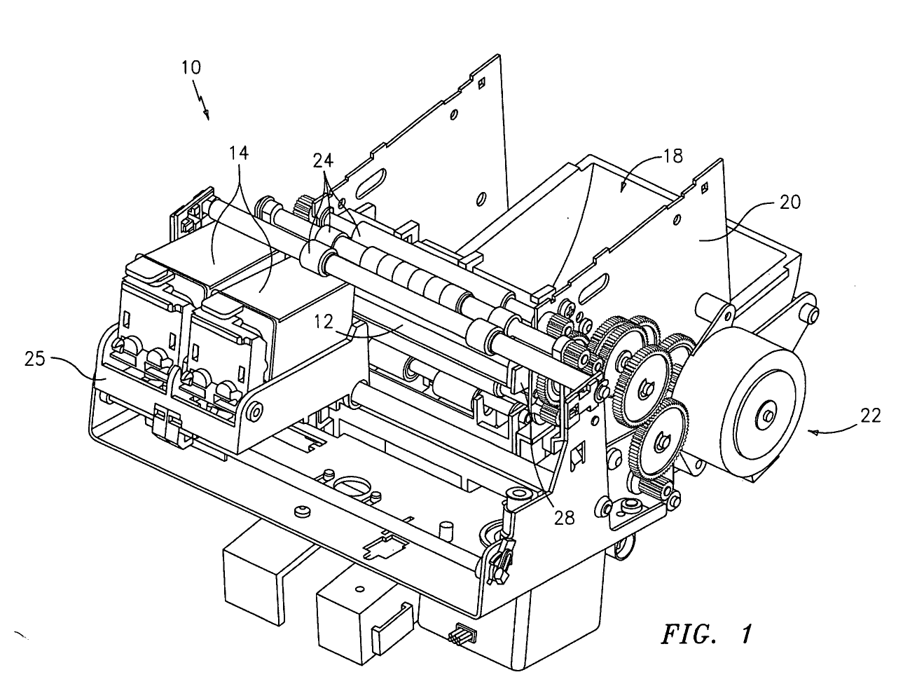

FIGS. 1-3 show an example embodiment of a two-pen ink jet printer apparatus 10 in accordance with the present invention (shown without covers). The printer 10 comprises a platen 12, two ink pens 14 with respective ink pen faces 16, a paper bin 18 (shown empty for clarity), and a pivoting frame 20. The ink jet printer also includes the necessary drive and gear assembly 22, rollers 24, a carriage 25 for housing and positioning the ink pens 14, and other structure typically associated with an ink-jet printer, as would be appreciated by those of ordinary skill in the art. A dual print head wiper apparatus 26 is mounted on or housed in the pivoting frame 20.

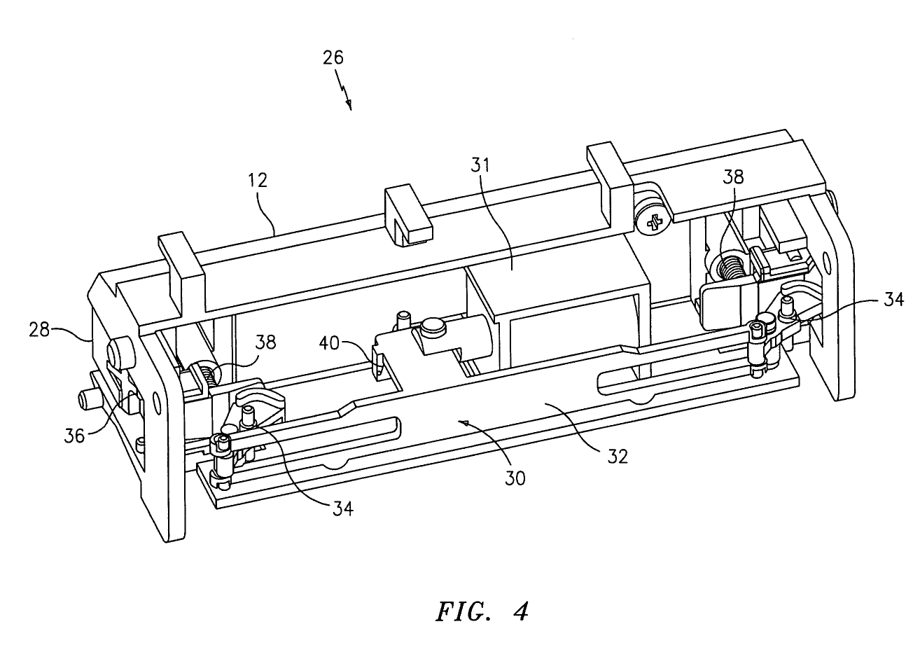

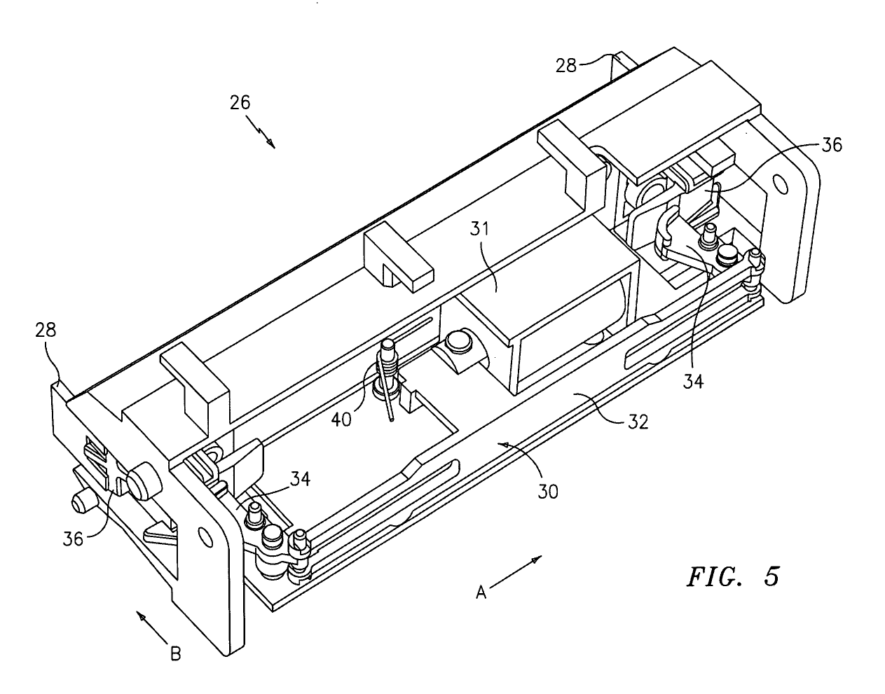

FIGS. 4 and 5 show an example embodiment of a dual print head wiper apparatus 26 for an ink jet printer in accordance with the present invention. The apparatus comprises two print head wipers 28, each print head wiper 28 adapted to wipe a respective ink pen face 16 of a corresponding ink pen 14. Linkage 30 is provided which connects the two print head wipers 28 together. A solenoid 31 connected to the linkage 30 is provided for actuating the two print head wipers 28 simultaneously.

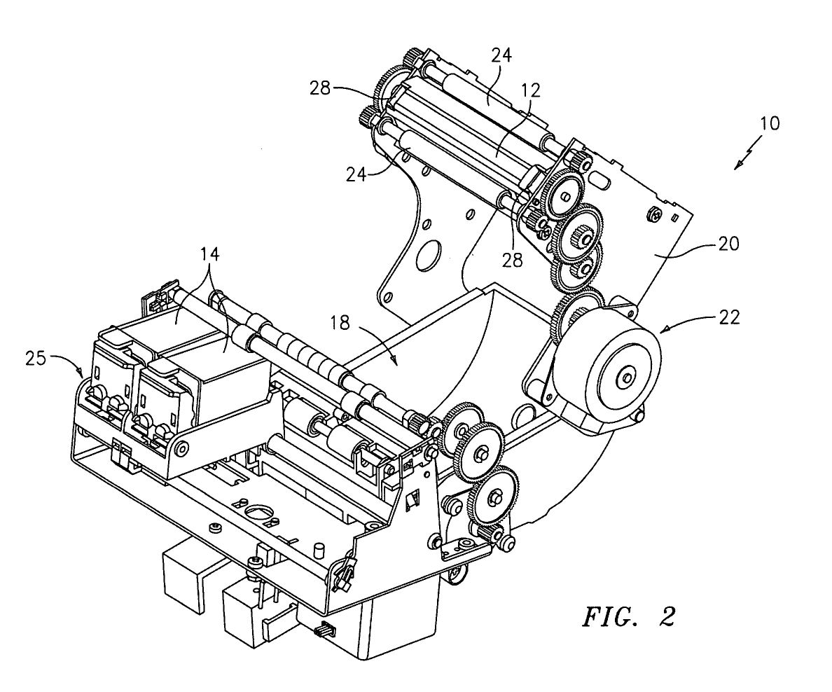

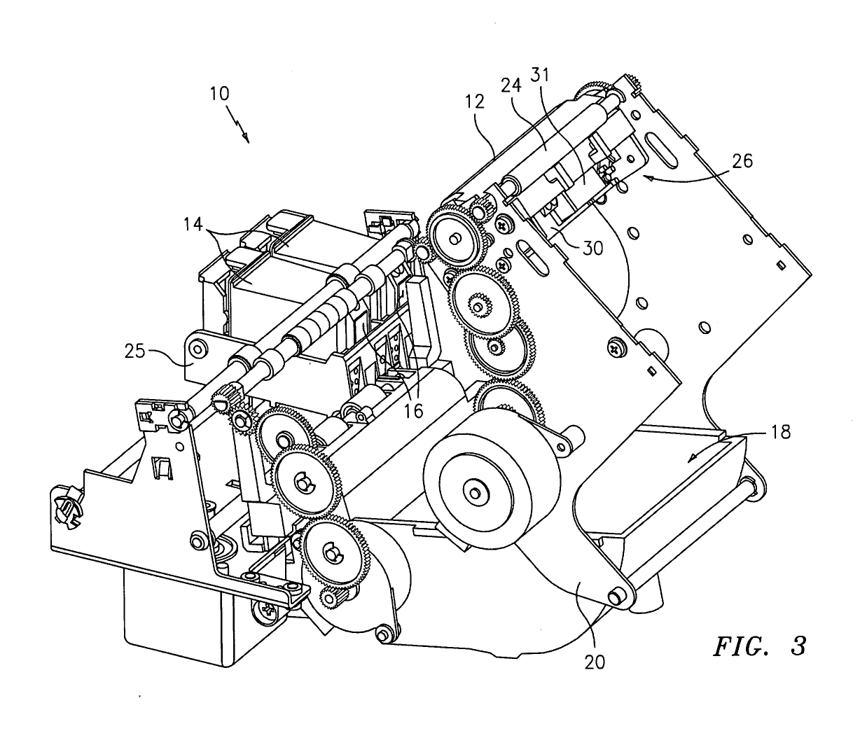

The pivoting frame 20 may pivot between a closed position (FIG. 1) and an open position (FIGS. 2 and 3). The open position shown in FIGS. 2 and 3 may permit drop-in paper loading and the closed position shown in FIG. 1 may enable the print head wipers 28 to engage the respective ink pen faces 14 upon actuation of the solenoid 31.

In one example embodiment of the present invention, the linkage 30 may comprise an elongated bracket 32 with a cam 34 pivotally mounted on each end of the bracket 32. Each of the cams 34 may interact with a respective wiper mount 36, each of which holds one of the two print head wipers 28. FIG. 4 shows the dual print head wiper apparatus 26 in an inactive position in which the solenoid 31 has not been activated and the wipers 28 are in a retracted position. FIG. 5 shows the dual print head wiper apparatus 26 in an active position in which the solenoid 31 has been activated and the wipers 28 are extended for engagement with the ink pen faces 16 of the ink pens 14.

As shown in FIG. 5, upon actuation of the solenoid 31, the bracket 32 may be moved in a first direction (Arrow A). The cams 34 may then translate motion from the first direction to a motion in a second direction (Arrow B) transverse to the first direction, such that the cams 34 displace the wiper mounts 36 in a the second direction shown by Arrow B, causing the wipers 28 to engage against and clean the corresponding ink pen faces 16 of the ink pens 14. The cams 34 also enable the print head wipers 28 to be locked in position when performing a wiping operation.

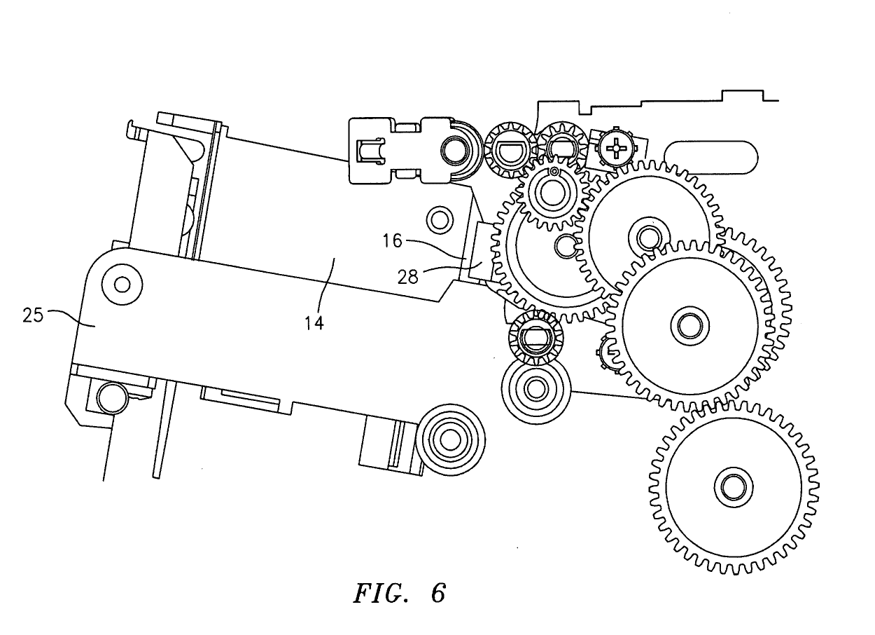

FIG. 6 shows a close up view of one of the wipers 28 extended in the active position and engaged with the ink pen face 16. The ink pen faces 16 are wiped by the print head wipers 28 as the carriage 25 moves the ink pens 14 past the wipers 28, which are temporarily locked in position during activation of the solenoid 31.

The actuation of the solenoid 31 and movement of the carriage necessary for a wiping operation is controlled by firmware resident in the printer 10. This firmware may cause the solenoid 31 to actuate such that the print head wipers 28 wipe the ink pen faces 16 under various circumstances, including but not limited the following: after installation of one or more new ink pens 14; after power-up of the printer 10; after opening and closing of the cover; after pivoting of the frame 20 from open to closed position; after a predetermined time period of printer inactivity; after predetermined periods of continuous printing; upon entering standby mode; upon leaving standby mode and resuming printer operations; and after a predetermined period of time in standby mode. It should be appreciated that the wiping action may in certain circumstances be preceded by a “spit” of ink from the ink pen faces 16, with different circumstances requiring different amounts of ink to be expelled prior to the wiping action. In addition, in certain circumstances a spit may occur after the wiping action. The carriage 25 may move the ink pens 14 into a “spit station” prior to the spit.

Return springs 38 may be provided which bias the respective wiper mounts 36 in a direction opposite the second direction. A solenoid linkage return spring 40 may also be provided which is biased to return the linkage 30 to a rest position in an un-activated state of the solenoid 31 (e.g., from the active state shown in FIG. 5 to the inactive state shown in FIG. 4).

It should now be appreciated that the present invention provides advantageous apparatus and methods for simultaneously cleaning both ink pen faces of a two-pen ink jet printer.

Although the invention has been described in connection with various illustrated embodiments, numerous modifications and adaptations may be made thereto without departing from the spirit and scope of the invention as set forth in the claims.

What is claimed is:

1. A dual print head wiper apparatus for an ink jet printer, comprising:
two print head wipers, each print head wiper adapted to wipe a respective ink pen face of a corresponding ink pen;
linkage connecting the two print head wipers together; and
a solenoid connected to the linkage for actuating the two print head wipers simultaneously.

2. A dual print head wiper apparatus in accordance with claim 1, further comprising:
a pivoting frame for housing the two print head wipers.

3. A dual print head wiper apparatus in accordance with claim 2, wherein:
the pivoting frame pivots between an open and a closed position;
the open position permits drop-in paper loading; and
the closed position enables the print head wipers to engage the respective ink pen faces.

4. A dual print head wiper apparatus in accordance with claim 1, further comprising:
a carriage for housing and positioning the ink pens; and
wherein said carriage moves the ink pens past the print head wipers after activation of the solenoid to initiate the wipe.

5. A dual print head wiper apparatus in accordance with claim 1, wherein:
the linkage comprises an elongated bracket with a cam pivotally mounted on each end of the bracket; and
the cams each interact with a respective wiper mount holding one of the two print head wipers.

6. A dual print head wiper apparatus in accordance with claim 5, wherein:
upon actuation of the solenoid, the bracket is moved in a first direction; and
the cams translate motion from the first direction to a motion in a second direction transverse to the first direction.

7. A dual print head wiper apparatus in accordance with claim 6, further comprising:
return springs biasing the respective wiper mounts in a direction opposite the second direction.

8. A dual print head wiper apparatus in accordance with claim 5, further comprising:
a linkage return spring biased to return the linkage to a rest position in an un-activated state of the solenoid.

9. A method for cleaning ink pen faces of a two-pen ink jet printer, comprising:
providing two print head wipers, each print head wiper adapted to wipe a respective ink pen face of a corresponding ink pen;
connecting the two print head wipers together; and
actuating the two print head wipers simultaneously.

10. A method in accordance with claim 9, wherein:
linkage is provided which connects to the two print head wipers together; and
a solenoid is provided for the simultaneous actuating of the print head wipers.

11. A method in accordance with claim 10, wherein:
the solenoid is connected to the linkage.

12. A method in accordance with claim 11, wherein:
the linkage comprises an elongated bracket with a cam pivotally mounted on each end of the bracket; and
the cams each interact with a respective wiper mount holding one of the two print head wipers.

13. A method in accordance with claim 12, wherein:
upon actuation of the solenoid, the bracket is moved in a first direction; and
the cams translate motion from a first direction to a motion in a second direction transverse to the first direction.

14. A method in accordance with claim 13, wherein:
return springs are provided which bias the respective wiper mounts in a direction opposite the second direction.

15. A method in accordance with claim 12, wherein:
a linkage return spring is provided which is biased to return the linkage to a rest position in an un-activated state of the solenoid.

16. A method in accordance with claim 10, wherein:
a carriage is provided for housing and positioning the ink pens; and
the carriage moves the ink pens past the print head wipers after activation of the solenoid to initiate the wipe.

17. A method in accordance with claim 9, wherein:
a pivoting frame is provided for housing the two print head wipers.

18. A method in accordance with claim 16, wherein:
the pivoting frame pivots between an open and a closed position;
the open position permits drop-in paper loading; and
the closed position enables the print head wipers to engage the respective ink pen faces.
